(19) United States
(12) Patent Application Publication
(10) Pub. No.: US 2004/0154741 A1
(43) Pub. Date: Aug. 12, 2004

(54) Manufacturing method for a striking plate of a putter head

(75) Inventor: Chih-Jen Fang, Kaohsiung (TW)

Correspondence Address: BACON & THOMAS, PLLC, 625 SLATERS LANE, FOURTH FLOOR, ALEXANDRIA, VA, 22314

(73) Assignee: Nelson Precision Casting Co., Ltd., Kaohsiung (TW)

(21) Appl. No.: 10/360,748

(22) Filed: Feb. 10, 2003

(51) Int. Cl. B32B 31/00

(52) U.S. Cl. 156/293

(57) ABSTRACT

A manufacturing method for a striking plate of a putter head comprises steps of: utilizing a first material to form a marking block in a predetermined configuration; utilizing a second material, which has color different from that of the first material, to form a substrate; embedding the marking block into the substrate to form an integrated member for the striking plate; and inserting the integrated member into a compartment of a main body to form the putter head.

### BACKGROUND OF THE INVENTION

1. Field of the Invention

The present invention is related to a manufacturing method for a striking plate of a putter head and more particularly to a manufacturing method utilizing different color materials to form a substrate and a marking area thereof, thereby accomplishing a durable pattern and advertisement.

2. Description of the Related Art

FIGS. 1 and 2 illustrate a conventional structure for a striking plate of a putter. Generally, the striking plate 10 is mounted in a compartment 21 formed on a front surface of a putter head 20. As to the manufacturing method for the striking plate 10, as shown in FIG. 1, it is made of rubber, resin or vibration-absorbable material. Alternatively, the striking plate 10 is attached to the compartment 21 by adhesive, or molded and hardened in the compartment 21. As shown in FIG. 2, the striking plate 10, such as a copper plate, can be made of vibration-absorbable metallic material and attached in the compartment 21.

However, the striking plate 10, made of any material, must be used to hit a golf ball, and thus, inevitably, it can abrade the surface of the striking plate 10 that no word, pattern, trademark and symbol printed thereon can be avoided the abrasion. Consequently, no vibrant pattern can be provided on the surface of the striking plate 10 even though it occupies a maximum area of the front surface of the putter head 20.

The present invention intends to provide a manufacturing method for a striking plate of a putter head, which utilizes different color materials to form a substrate and a marking area combined therewith. Various words, patterns, trademarks and symbols are able to form in the marking area, thereby marking a durable pattern and advertisement in such a way to mitigate and overcome the above problem.

### SUMMARY OF THE INVENTION

The primary objective of this invention is to provide a manufacturing method for a striking plate of a putter head, which is formed a substrate and a marking area thereof with different color material to appear various words, patterns, trademarks and symbols, thereby marking a durable pattern and advertisement.

The secondary objective of this invention is to provide the manufacturing method for the striking plate of the putter head adapted to form with a marking area, which is incorporated into the material of the striking plate to avoid peeling off, thereby marking a durable pattern and advertisement.

The manufacturing method for the striking plate of the putter head in accordance with the present invention comprises steps of: utilizing a first material to form a marking block in a predetermined configuration; utilizing a second material, which has color different from that of the first material, to form a substrate; embedding the marking block into the substrate to form an integrated member for the striking plate; and inserting the integrated member into a compartment of a main body to form the putter head.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a front view of a conventional putter head in accordance with the prior art;

FIG. 2 is a front view of a conventional putter head in accordance with the prior art;

FIG. 3 is a front view of a putter head in accordance with a first embodiment of the present invention;

FIG. 4 is a block diagram of a manufacturing method for a striking plate of the putter in accordance with the first embodiment of the present invention;

FIG. 5 is a front view of the putter head in a first manufacturing step in accordance with the first embodiment of the present invention;

FIG. 6 is a cross-sectional view, taken along line 6-6 in FIG. 5, of the putter head in accordance with the first embodiment of the present invention;

FIG. 7 is a cross-sectional view of the putter head in the first manufacturing step in accordance with the first embodiment of the present invention;

FIG. 8 is an exploded view of a putter head in a first manufacturing step in accordance with a second embodiment of the present invention;

FIG. 9 is an exploded view of a putter head in a first manufacturing step in accordance with the second embodiment of the present invention;

FIG. 10 is a perspective view of a striking plate in accordance with a third embodiment of the present invention;

FIG. 11 is a cross-sectional view, taken along line 11-11 in FIG. 10, of the striking plate in accordance with the third embodiment of the present invention;

FIG. 12 is a cross-sectional view of a striking plate in accordance with the third embodiment of the present invention; and

FIG. 13 is a perspective view of a putter head in accordance with a fouth embodiment of the present invention.

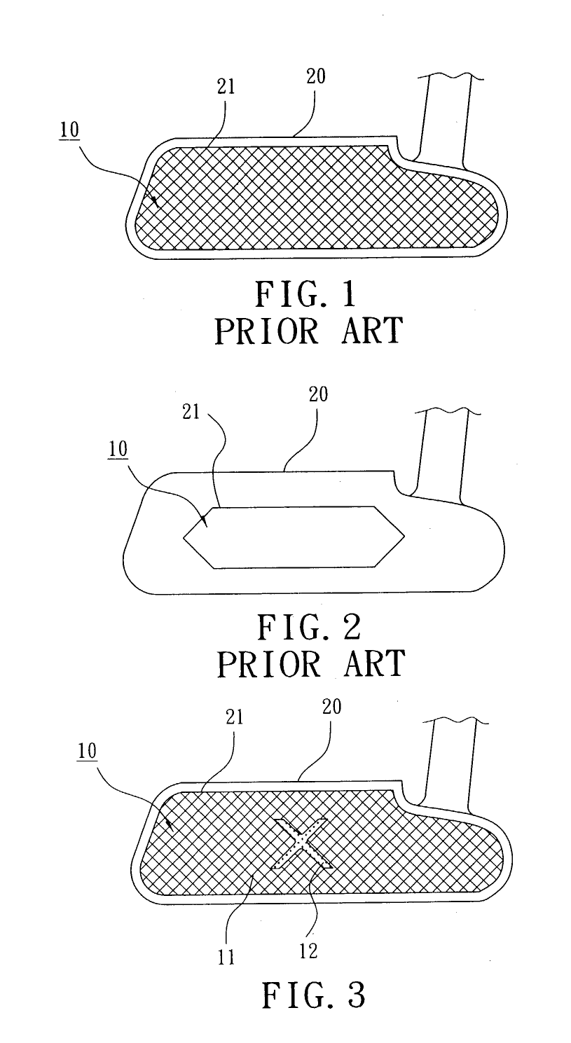

### DETAILED DESCRIPTION OF THE INVENTION

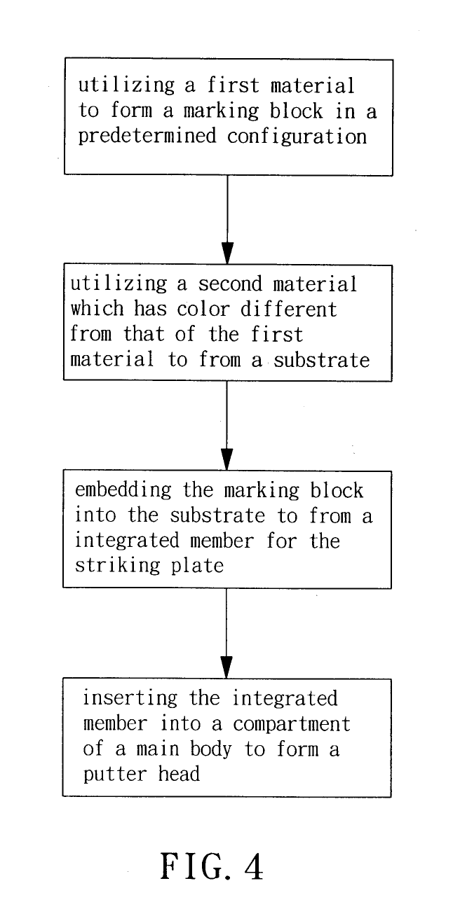

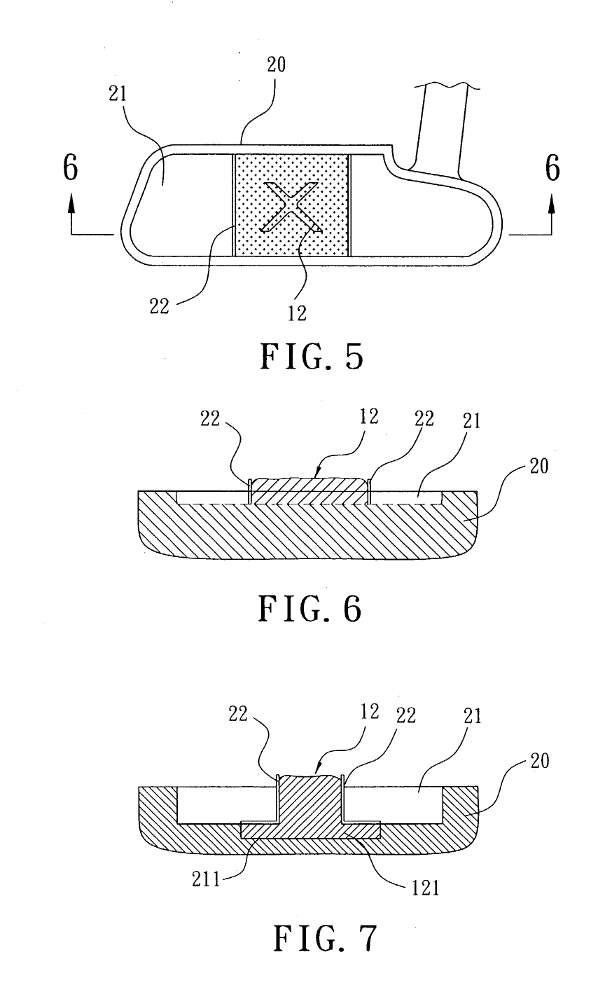

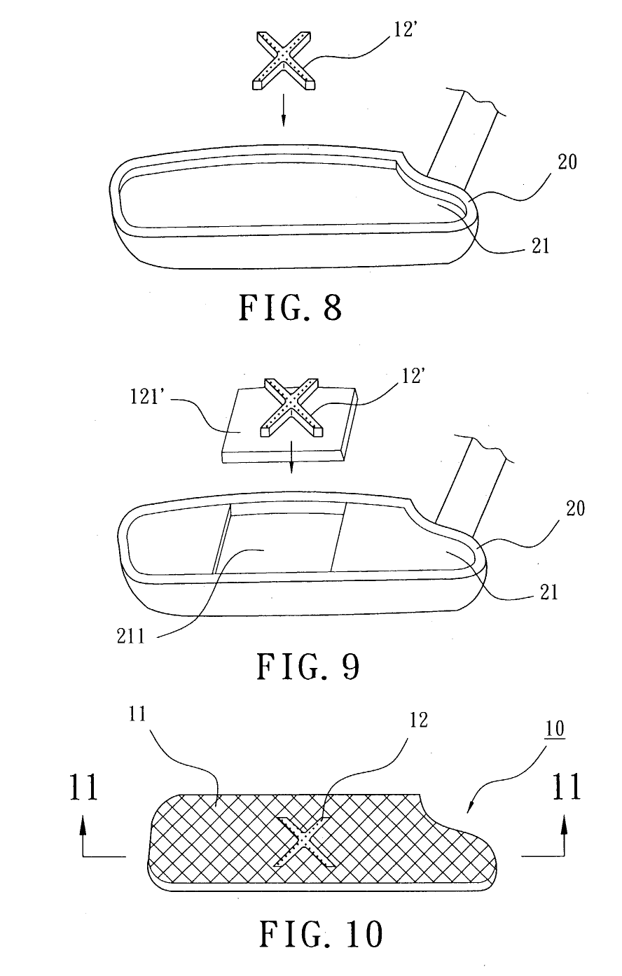

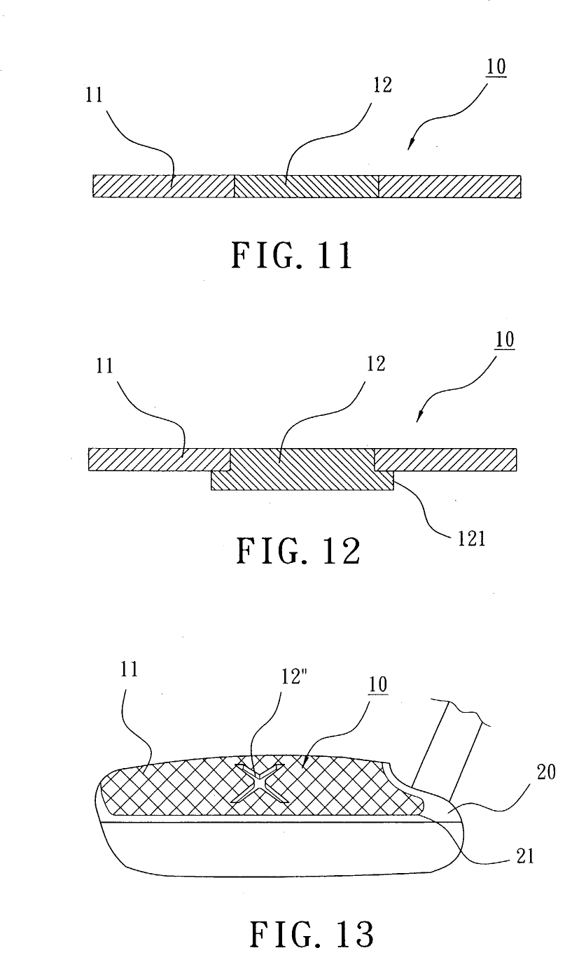

Referring to FIGS. 3 through 13, reference numerals of the embodiments have applied the identical numerals of the conventional putter head. The putter head of the embodiments has the similar configuration and same function as the conventional putter head and the detailed descriptions are omitted.

The manufacturing method in accordance with the present invention comprises steps of: utilizing a first material to form a marking block in a predetermined configuration; utilizing a second material, which has color different from that of the first material, to form a substrate; embedding the marking block into the substrate to form an integrated member for the striking plate; and inserting the integrated member into a compartment of a main body to form the putter head.

Referring to FIG. 3, it illustrates an essential structure of a striking plate 10 of a putter head in accordance with a first embodiment of the present invention. The striking plate 10 includes a substrate 11 formed with a mark hole, and a marking block 12 embedded in the mark hole. Alternatively, the substrate 11 and the marking block 12 are molded at the same time, or they are preset and then attached to a compartment 21 formed on a front surface of the putter head. The substrate 11 surrounds the mark hole adapted to receive the marking block 12, thereby combining with the marking block 12. To accomplish a pattern and an advertisement, the marking block 12 is adapted to form with various colors, patterns, trademark and symbols. Moreover, the substrate 11 and the marking block 12 are in different colors and made of different materials, which are vibration-absorbable material, such as epoxy, resin and rubber. Preferably, the substrate 11 and the marking block 12 are made of the same material and thus it can avoid cracks in the striking plate 10 caused by unbalanced stress on different physical aspects (such as elasticity, rigidity) while striking.

There are four embodiments of the manufacturing methods for the striking plate 10 shown in the drawings. The striking plate 10 is consisted of a substrate 11 and a marking block 12 embedded therein to thereby avoid peeling off and increase a durable pattern and advertisement.

Referring to FIGS. 3 through 6, a manufacturing method in accordance with the first embodiment of the present invention utilizes a molding manner and a milling manner for forming a substrate 11 and a marking block 12 of a striking plate 10. Firstly, a first material, such as epoxy, is directly molded in a compartment 21 of a putter head 20 to form a marking block 12. A barrier 22 (for example aluminum foil, paper sheet, and metal sheet) is fixed in the compartment 21 to space a compartment at a predetermined position and the first material is molded therein to form a raw plate for the marking block 12. After the first material is hardened, the barrier 22 is removed. A CNC milling machine (not shown) mills the raw plate to cut a redundant portion for forming the marking block 12 in a predetermined configuration. Secondly, a second material is molded in the compartment 21 to fill the rest space around the marking block 12 that the second material buries the marking block 12. Preferably, the second material has different color from the first material, but it has the same material. After hardening, the first and second materials are slightly protruded from the surface of the putter head 20 and it is necessary to level the substrate 11 and the marking block 12 on the surface. Thirdly, the marking block 12 is embedded in the substrate 11 after hardening, and then the CNC milling machine further mills the redundant material protruded from the surface of the putter head 20 that the striking plate 10 is formed with durable desired pattern and advertisement.

Referring to FIGS. 3, 5 and 7, the manufacturing method in accordance with the first embodiment of the present invention utilizes a putter head 20 further provided with a compartment 21 and a bottom recession 211 formed therein. When the first material is molded in the compartment 21 and the bottom recession 211, the marking block 12 is formed with a base 121. After embedding in the substrate 11, the marking block 12 is confined within the recession 221 in engagement of the base 121 with the substrate 11. Consequently, it can avoid peeling off and increase durability.

Referring to FIGS. 3, 4 and 8, a manufacturing method in accordance with a second embodiment of the present invention a pre-molding manner and a molding manner for forming a marking block 12 and a substrate 11 of a striking plate 10. Firstly, a first material is molded in a mold assembly (not shown) to form a prefabricated pattern 12′. Preferably, a thickness of the prefabricated pattern 12′ is slightly thicker than a depth of a compartment 21 for leveling operation. The prefabricated pattern 12′ is directly adhered to the bottom of the compartment 21 to form the marking block 12. Secondly, a second material is molded in the compartment 21 to fill the rest space around the marking block 12 that the second material buries the marking block 12. Preferably, the second material has different color from the first material, but it has the same material. After hardening, the first and second materials are slightly protruded from the surface of the putter head 20 and it is necessary to level the substrate 11 and the marking block 12 on the surface. Thirdly, the marking block 12 is embedded in the substrate 11 after hardening, and then the CNC milling machine further mills the redundant material protruded from the surface of the putter head 20 that the striking plate 10 is formed with durable desired pattern and advertisement.

Referring to FIGS. 3, 4 and 9, the manufacturing method in accordance with the second embodiment of the present invention utilizes a putter head 20 further provided with a compartment 21 and a bottom recession 211 formed therein. The first material is molded in the mold assembly to form a prefabricated pattern 12′ and a base 121′ attached thereto. The base 121′ is directly adhered to the bottom of the compartment 21 to form the marking block 12. After embedding in the substrate 11 the marking block 12 is confined within the recession 221 in engagement of the base 121′ with the substrate 11. Consequently, it can avoid peeling off and increase durability.

Referring to FIGS. 3, 4, 10 and 11, a manufacturing method in accordance with a third embodiment of the present invention a pre-molding manner and an adhering manner for forming a marking block 12 and a substrate 11 of a striking plate 10. Firstly, a first material is molded in a first mold assembly (not shown) to form a prefabricated pattern 12′. Secondly, the prefabricated pattern 12′ is positioned in a second mold assembly (not shown) for molding a substrate 11. Thirdly, a second material is molded in the second mold assembly to form a striking plate 10 with a predetermined configuration, durable desired pattern and advertisement. Fourthly, the striking plate 10 is adhered to the compartment 21 of the putter head 20. In comparison with the first and second embodiments, the third embodiment cancels the CNC milling operation on the striking plate 10.

Referring to FIGS. 3, 4, 10 and 12, the manufacturing method in accordance with the third embodiment of the present invention utilizes the first material molded in the mold assembly to form a prefabricated pattern 12′ and a base 121′ attached thereto. The base 121′ is corresponding to the bottom of the compartment 21 to form the marking block 12 when assembled. Similarly, it can avoid peeling off and increase durability.

Referring to FIGS. 3, 4 and 13, a manufacturing method in accordance with a fourth embodiment of the present invention a molding manner and a milling manner for forming a substrate 11 and a marking block 12 of a striking plate 10. In comparison with the first embodiment, the fourth embodiment is inverted the steps in sequence. Firstly, a first material is directly molded and hardened in a compartment 21 of a putter head 20 to form a substrate 11. Preferably, the thickness of the substrate 11 is slightly thicker than the depth of the compartment 21. Secondly, a CNC milling machine mills the substrate 11 to cut a redundant portion for forming the mark hole 12″ in a predetermined configuration. Thirdly, a second material is molded in the mark hole 12″ to form a marking block 12 that the second material buries the marking block 12. After hardening, the first and second materials are slightly protruded from the surface of the putter head 20 and it is necessary to level the substrate 11 and the marking block 12 on the surface. Fourthly, the CNC milling machine further mills the redundant material protruded from the surface of the putter head 20 that the striking plate 10 is formed with durable desired pattern and advertisement.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A manufacturing method for a striking plate of a putter head, comprising steps of:
molding a first material to form a marking block in a predetermined configuration;
molding a second material to form a substrate;
embedding the marking block into the substrate to form an integrated member for the striking plate; and
inserting the integrated member into a compartment of a main body to form the putter head.

2. The manufacturing method as defined in claim 1, wherein the first material has a color different from that of the second material.

3. The manufacturing method as defined in claim 1, wherein the first and second materials are selected from epoxy, resin, or rubber.

4. The manufacturing method as defined in claim 1, wherein the marking block is adapted to form words, patterns, trademarks and symbols.

5. The manufacturing method as defined in claim 1, wherein the marking block is attached to a base which is adapted to correspond to a bottom recession formed in the compartment.

6. The manufacturing method as defined in claim 1, wherein the marking block is formed in the compartment by a molding manner and a milling manner.

7. The manufacturing method as defined in claim 1, wherein the substrate is formed in the compartment by a molding manner and a milling manner.

8. The manufacturing method as defined in claim 1, wherein the marking block is formed in the compartment by a pre-molding manner and a adhering manner.

9. The manufacturing method as defined in claim 1, wherein the substrate is formed in the compartment by a pre-molding manner and a adhering manner.

10. A manufacturing method for a striking plate of a putter head, comprising steps of:
molding a first material to form a substrate in a compartment of a main body;
milling the substrate to form a mark hole;
molding a second material in the mark hole to form a marking block so as to constitute an integrated member for the striking plate; and
inserting the integrated member into a compartment of a main body to form the putter head.

11. The manufacturing method as defined in claim 10, wherein the first material has a color different from that of the second material.

12. The manufacturing method as defined in claim 10, wherein the first and second materials are selected from epoxy, resin, or rubber.

13. The manufacturing method as defined in claim 10, wherein the marking block is adapted to form words, patterns, trademarks and symbols.
